(19) United States
(12) Patent Application Publication
(10) Pub. No.: US 2019/0140416 A1
(43) Pub. Date: May 9, 2019

(54) Cladding-Pumped Hybrid Amplification Structure And Method

(71) Applicant: OFS Fitel, LLC, Norcross, GA (US)

(72) Inventors: Kazi S. Abedin, Basking Ridge, NJ (US); David J. DiGiovanni, Mountain Lakes, NJ (US)

(73) Assignee: OFS Fitel, LLC, Norcross, GA (US)

(21) Appl. No.: 15/938,019

(22) Filed: Mar. 28, 2018

Related U.S. Application Data
(60) Provisional application No. 62/581,909, filed on Nov. 6, 2017.

(51) Int. Cl. H01S 3/094; H01S 3/067; H01S 3/16

(52) U.S. Cl. CPC H01S 3/094007; H01S 3/06745; H01S 3/094042; H01S 3/094069; H01S 3/06779; H01S 3/1608; H01S 3/06783; H01S 3/06716; H01S 3/1618

(57) ABSTRACT

A fiber amplifier has a first amplification stage and a second amplification stage. The first amplification stage comprises a first gain fiber that is configured to receive, at its input end, a signal light and a pump light. The first gain fiber uses a portion of the pump light to provide first-stage amplification to the signal light. The second amplification stage comprises a second gain fiber that is configured to receive, at its input end, the first-stage-amplified signal light and residual pump light. The second gain fiber uses the residual pump light to provide second-stage amplification of the first-stage-amplified signal light and to provide, at its output end, the second-stage amplified signal light. The first amplification stage may include a single-mode gain fiber, and the second amplification stage may include a higher-order-mode gain fiber, and the first amplification stage may be configured to provide single-mode amplification of a sub-threshold input to satisfy the low-ASE threshold of the second amplification stage.

### CROSS REFERENCE TO RELATED APPLICATIONS

The present application claims the priority benefit of U.S. Provisional Patent Application Ser. No. 62/581,909, filed on Nov. 6, 2017, which is owned by the assignee of the present application, and which is incorporated herein by reference in its entirety.

### BACKGROUND OF THE INVENTION

### Field of the Invention

The present invention relates generally to the field of fiber optics, and in particular to an improved cladding-pumped hybrid amplification structure and method.

### Background Art

A higher-order-mode fiber amplifier has the potential to generate optical pulses one to two orders of magnitudes higher than that achievable from an amplifier operating in the fundamental LP_{(0,1)} mode, owing to the HOM fiber amplifier's large effective area which can be a few thousand micrometers μm². Typically, the HOM gain fiber has an inner core capable of guiding the fundamental waveguide mode, and a rare-earth-doped concentric outer core for guiding and amplifying higher-order mode.

There are two problems associated with a conventional Yb-doped higher-order mode (HOM) amplifier configured for multimode cladding pumping. First, an HOM-amplifier may have a large core diameter, e.g., on the order of ˜100 μm and may thus display an unacceptably large amount of amplified-spontaneous-emission (ASE) noise, due to the presence of hundreds of modes supported by the large core. In order to suppress this ASE, and to achieve high slope efficiency, a signal with higher average power (˜1 W or more) must be injected into the HOM amplifier. However, for pulsed operation, it is difficult to provide an input signal with the required high average power because of various nonlinear effects.

Another problem, associated with cladding-pumped operation of a HOM amplifier for both continuous-wave (CW) and pulsed operation, is related to maintaining the purity of a higher-order mode launched into the gain fiber. When a single-mode signal light is launched into the signal port of a tapered fiber bundle (TFB), which combines the signal light and a multimode pump light, a fraction of the launched signal light resides in the cladding region of the output fiber port of the TFB, rather than in the core region. The amount of signal light residing in the cladding could amount to as much as 10%, depending upon the extent of splice loss and imperfections in the TFB fabrication. At least some of the cladding-guided signal light enters the active, rare-earth doped region of the HOM amplifier where it is amplified in combination with the core-guided signal light, resulting in a degradation of the modal purity of the amplified HOM output.

### SUMMARY OF INVENTION

An aspect of the invention is directed to a fiber amplifier comprising a first amplification stage and a second amplification stage. The first amplification stage comprises a first gain fiber that is configured to receive, at its input end, a signal light and a pump light. The first gain fiber uses a portion of the pump light to provide first-stage amplification to the signal light. The second amplification stage comprises a second gain fiber that is configured to receive, at its input end, the first-stage-amplified signal light and residual pump light. The second gain fiber uses the residual pump light to provide second-stage amplification of the first-stage-amplified signal light and to provide, at its output end, the second-stage amplified signal light.

According to a further aspect of the invention, the first amplification stage comprises a single-mode gain fiber, and the second amplification stage comprises a higher-order-mode gain fiber. The first amplification stage is configured to provide single-mode amplification of a sub-threshold input to satisfy the low-ASE threshold of the second amplification stage.

### BRIEF DESCRIPTION OF THE DRAWINGS

FIG. 1 shows a schematic diagram of a hybrid cladding-pumped amplifier according to an aspect of the invention, and

FIG. 2 shows an exploded view of the amplifier, in which the amplifier components have been separated and grouped into functional blocks.

FIG. 3 shows a combined graph illustrating the characteristics of the intensity profile of the fundamental mode and a higher-order mode (LP_{0,10}) in relation to the refractive index profile of an exemplary ytterbium-doped HOM fiber.

FIG. 4 shows a schematic diagram of a cladding-pumped HOM amplifier according to the prior art, having only a single amplification stage.

FIGS. 5A and 5B are graphs that show the pump, signal, and ASE power distributions (forward-propagating and backward-propagating), numerically simulated, for a single-stage cladding-pumped HOM amplifier structure according to FIG. 4 operating, respectively, with a signal input of 1 W and 100 mW.

FIG. 6A is a graph illustrating the amplification characteristics of a cladding-pumped single-mode gain fiber, 11/200 (mode field diameter 11 μm, cladding diameter 200 μm), amplifier. FIG. 6B is a graph illustrating the unabsorbed pump light emitted by the single-mode amplifier having different lengths, and operating at a different levels of input signal. Pump power (975 nm) is held constant at 235 W.

FIG. 7A is a graph comparing the amplification characteristics of cladding-pumped single mode gain fiber (11/200) amplifier at three different lengths. FIG. 7B is a graph 150 shows residual pump light as a function of incident pump light for the three lengths. Input signal power is held constant at 50 mW.

FIG. 8A and FIG. 8B are graphs 160 and 170 show the dependence of gain on the length of the single mode Yb gain fiber (11/200), calculated for different amount of multimode pump light (975 nm) launched through the cladding. Input signal power is held constant at 50 mW.

FIG. 9A is a graph 180 showing the optical spectra of the amplifier output for the following pump powers: 0 W, 25 W, 50 W, 75 W, 100 W, 125 W. FIG. 9B is a graph showing the average output power plotted as a function of pump power.

FIG. 10 is a graph showing the optical spectra of the amplifier output at pump powers of 0 W and 25 W.

FIG. 11 is a flowchart of a general method according to a further aspect of the invention for providing higher-order-mode amplification of a signal light having a power level below a low-ASE signal input threshold of a higher-order-mode gain fiber.

FIG. 12 shows a table laying out the parameters of an exemplary hybrid Yb:HOM amplifier according to an aspect of the invention.

FIG. 13 is a graphical representation showing the required value for Q for different output powers of a stage 1 amplifier.

FIG. 14 shows a pair of graphical representations illustrating nonlinear spectral broadening as a function of Q, and nonlinear spectral broadening as a function of the output of the stage 1 amplifier, plotted for different gain coefficients.

FIG. 15 shows a pair of graphical representations illustrating signal-to-noise ratio as a function of Q, and signal-to-noise ration as a function of the output of the stage 1 amplifier, plotted for different gain coefficients.

FIG. 16 is a flowchart setting forth the steps in the design of an HOM amplifier according to an aspect of the invention.

### DETAILED DESCRIPTION

Aspects of the invention are directed to a hybrid amplification structure that, in an exemplary practice, is used to implement a cladding-pumped HOM amplifier having a relatively low signal input (i.e., on the order of 100 mW or less), while at the same time achieving an output having an acceptably low level of amplified-spontaneous-emission (ASE) noise and a high degree of modal purity.

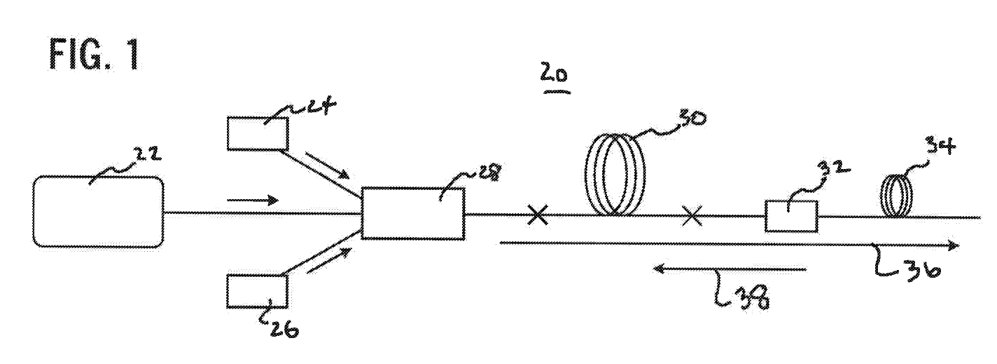

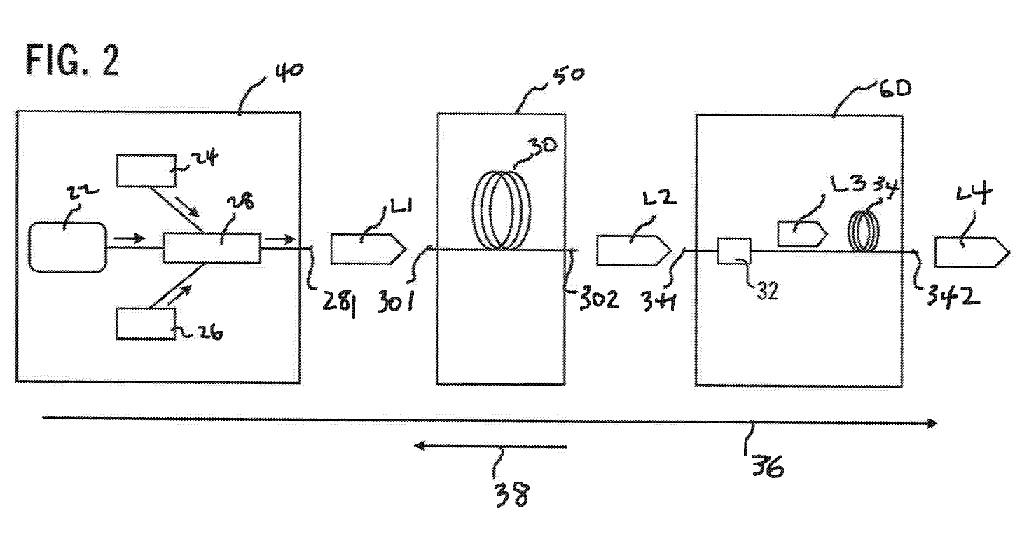

FIG. 1 shows a schematic diagram of a hybrid cladding-pumped amplifier 20 according to the invention, and FIG. 2 shows an exploded view of the amplifier, in which the amplifier components have been separated and grouped into functional blocks.

In FIG. 1, block 22 represents a signal source (or seed source) that provides a signal light (or seed light) to be amplified. As used herein, the terms “signal” and “seed” are used interchangeably to refer to a light to be amplified. Blocks 24 and 26 represent pump sources that provide multimode pump light. Signal light from signal source 22 and pump light from pump sources 24 and 26 are launched into a pump-and-signal combiner, represented by block 28. The combined pump and signal light travels through a first gain fiber 30, a mode converter 32, and a second gain fiber 34.

As used herein, the term “forward” refers to the direction indicated by arrow 36, i.e., the direction in which light travels as it propagates from the signal source 22 and pump sources 24, 26 through the first and second gain fibers 30, 34. The opposite direction, indicated by arrow 38, is referred to herein as the “backward” direction.

In FIG. 2, the components of amplifier 20 have been separated into the following three functional groups:

an input stage 40, comprising signal source 22, pump sources 24 and 26 and a pump/signal combiner 28 having a forward (i.e., output) port 281;

a first amplification stage 50 (also referred to herein as a “pre-amplification stage”), comprising the first gain fiber 30, which has a backward (i.e., input) end 301, and a forward (i.e., output) end 302; and

a second amplification stage 60, comprising the second gain fiber 34, which has a backward (i.e., input) end 341, and a forward (i.e., output) end 342;

FIG. 2 further illustrates the light inputs and outputs of the three amplification stages.

Signal light from signal source 22 and pump light from pump sources 24 and 26 are launched into the combiner 28, which then provides a combined signal/pump light L1 as an output at port 281.

Light L1 is then launched from port 281 into the first gain fiber's backward end 301. The first gain fiber uses the pump light component of light L1 to provide first-stage amplification of the signal component of light L1. The first-stage-amplified signal light and the residual pump light are then provided as an output L2 at the first gain fiber's forward end 302.

Light L2, which comprises first-stage-amplified signal light and residual pump light, is then launched from the first gain fiber's forward end into the second gain fiber's backward end 341. Mode converter 32 converts the signal component of light L2 to a higher-order-LP-mode light L3, which is then amplified by the second gain fiber 34, using residual pump light to provide second-stage amplification of the mode-converted signal component of light L2. The second-stage-amplified signal light is provided as the amplifier output L4 at the forward (i.e., output) end of the second gain fiber 342.

According to an aspect of the invention, the configuration illustrated in FIGS. 1 and 2 is used in the context of a cladding-pumped higher-order mode (HOM) fiber amplifier. The hybrid architecture described herein preserves the advantages of an HOM fiber amplifier, in particular, the ability of an HOM fiber amplifier to provide significantly greater amplification than a fundamental-mode amplifier, while substantially eliminating signal loss due to ASE buildup and modal impurities.

The first gain fiber 30 comprises a single-mode gain fiber configured to act as a high-gain, single-mode pre-amplifier. As used herein, the terms “fundamental LP mode” and “LP_{(0,1)} mode” are used interchangeably to refer to the lowest-order linearly polarized (LP) mode, which has the narrowest mode field diameter (and also the smallest effective area) of all of the LP modes. The term “single-mode gain fiber” refers to an optical fiber having an active (i.e., rare-earth-doped) region with a cross-sectional geometry that supports the amplification of light in the LP_{(0,1)} mode, while not guiding higher-order LP modes.

The second gain fiber 34 comprises a higher-order-mode gain fiber. The term “higher-order-mode gain fiber” or “HOM fiber” refers to an optical fiber having an active region with a cross-sectional geometry that supports the amplification of light propagating in a higher-order LP mode (i.e., a mode other than the LP_{(0,1)} mode). Typically, an HOM gain fiber has an inner core configured to guide the LP_{(0,1)} waveguide mode, and a rare-earth-doped concentric outer core for guiding and amplifying higher-order modes.

In the presently described practice of the invention, signal source 22 may have either a continuous-wave (CW) or pulsed output. Pump sources 24 and 26 comprise a suitable number of multimode laser diodes. For example, depending upon a given implementation of the invention, the number of multimode laser diodes may correspond to the number of multimode pump ports of the pump/signal combiner 28. The pump/signal combiner comprises a tapered fiber bundle (TFB) having an output port that is spliced, with low loss, to the backward (i.e., input) end of the single-mode gain fiber. The LP_{(0,1)} output of the first gain fiber is converted to the LP_{(0,10)} mode (or other selected higher-order mode or combination of modes) by a long-period grating 32 or other suitable mode conversion device or means. Only a small portion of the pump light to component of combined light L1 is used to pump the first amplification stage. The unused pump light propagates through the cladding of the first gain fiber into the second gain fiber and is used to pump the second amplification stage.

The purpose of the first amplification stage is to amplify a low-power signal input light to a higher power level before it is launched into the second amplification stage.

As discussed below, one way to reduce ASE in an HOM fiber amplifier is to operate the amplifier with a signal light input having a relatively high power level. As discussed below, for a given HOM gain fiber, the power level required to reduce ASE can be determined, for example, by simulating the operation of the HOM gain fiber at various signal light and pump light power levels and examining the resulting output in the forward direction, which includes amplified signal light, forward ASE, and residual (i.e., unused) pump light, as well as in the backward direction comprised of backward ASE An input power level can then be selected based upon a given set of input parameters and an acceptably low percentage of ASE in the HOM gain fiber output.

For the purposes of the present description, for a given HOM gain fiber providing a given level of amplification of a signal input, a signal input power level resulting in an acceptably low ASE component in the HOM gain fiber output is generally referred to herein as a “low-ASE power level.” The lowest signal input power level resulting in an acceptably low ASE is referred to herein as the “low-ASE threshold.” A power level below the low-ASE threshold is referred to herein as a “sub-threshold” input power level. In an exemplary ytterbium-doped HOM gain fiber, discussed below, the low-ASE input power threshold was determined to be approximately 1 W.

In certain applications, it is not feasible to provide a signal light input having a power level that satisfies the low-ASE threshold. As discussed below, a signal light source may be limited to a power level of 100 mW (i.e., one-tenth of the required power level).

The first amplification stage 50 provides single-mode amplification of a sub-threshold signal light (e.g., ˜100 mW) to a low-ASE power level (˜1 W). Because of the relatively small modefield of a single-mode gain fiber, ASE is not an issue in the first amplification stage. In addition, because a single-mode gain fiber is configured to support propagation of only the LP_{(0,1)} mode signal light, the signal launched into the second amplification stage has high modal purity, particularly where a spatial mode converter, such as a long-period grating, converts the LP_{(0,1)} mode output of the first amplification stage into a suitable higher-order mode, such as the LP_{(0,1)} mode.

A suitable length for the single-mode gain fiber can be determined by simulating the operation of the fiber while varying the input parameters. Generally speaking, the single-mode gain fiber must have a length that is sufficient, given the power level of the pump light input, for the performance of the above-described preamplification of the light signal input. In addition, the single-mode gain fiber must have a length that is sufficiently short to avoid nonlinearities and other issues arising from the power levels of the pump light input. In an exemplary practice of the invention, discussed below, a suitable length for the single-mode gain fiber was determined to be less than 1 m.

The required power level of the pump light input into the hybrid amplifier can also be determined through simulations that take into account a number of factors, including the power level of the input signal light, the desired power level of the amplifier output, the amplification characteristics of the first and second amplification stages, and the amount of residual (i.e., unused) pump light traveling from the first amplification stage into the second amplification stage.

In an exemplary practice, the first gain fiber amplifies a sub-threshold 100 mW signal input to a low-ASE power level of approximately 1 W. The first gain fiber is pumped using a multimode pump light at a relatively high power level, ranging from tens of watts to a few hundred watts, in order to ensure high population inversion and operation in the unsaturated region. The second gain fiber uses the residual pump light to amplify the 1 W output of the first gain fiber to an output power level ranging from several tens of watts to over 100 W of average power.

The cross-sectional area of the rare-earth doped region of the single-mode gain fiber is relatively small. Thus, the amplified spontaneous emission (ASE) generated from quantum noise is minimized, and the weak signal can be amplified with a high signal-to-noise ratio (SNR). The length of the single-mode gain fiber is chosen so that the nonlinear impairment within the fiber is minimal.

The HOM gain fiber, which has a larger active doped area, can support hundreds of modes. However, since the average power of the signal power entering the HOM fiber is high, e.g., over 1 W, it can effectively suppress amplification of quantum noise produced by all of the supported modes. The HOM signal thus can be amplified efficiently, allowing high pump-to-signal conversion efficiency. Moreover, due to the large effective area of the HOM mode with which the signal propagates in the HOM fiber, nonlinear impairments can be efficiently suppressed.

An amplifier according to the present invention can help to improve the modal purity of the HOMs being amplified. Since the first amplifier section is single-moded, it only amplifies the light guided in the core, leaving any signal light in the cladding region unamplified, which may result while combining the signal and pump using the combiner. The amplifier can thus greatly to improve the purity (from 90% to 99%) of the LP_{(0,1)} signal light entering the mode converter, if we assume a 10 dB gain in stage 1.

As mentioned above, a higher-order-mode fiber amplifier has the potential to generate optical pulses one to two order of magnitudes higher than that achievable from an amplifier operating in the fundamental LP_{(0,1)} mode, owing to the HOM fiber amplifier's large effective area which can be as large as a few thousand micrometers μm².

According to a further aspect of the invention, a suitable long-period grating is inscribed into the HOM fiber proximate to its input end. The amplified output from the first amplification stage enters the HOM gain fiber and is converted into a selected HOM mode by the LPG. In the present example, the HOM fiber 34 comprises a waveguide that is configured to support the propagation of the LP_{(0,10)} mode, a symmetric higher-order mode. Accordingly, the LPG is configured to convert the LP_{(0,1)} output of the first gain fiber into the LP_{(0,10)} mode.

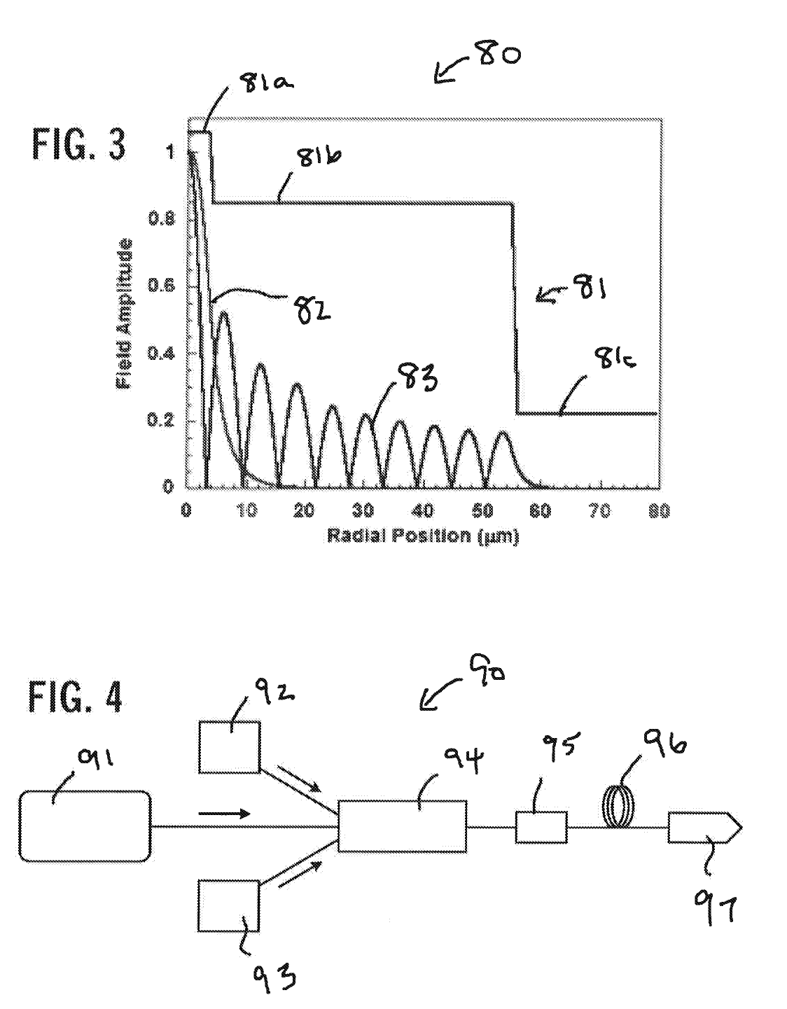

FIGS. 3-8 show a number of simulations that provide a theoretical framework for an understanding as to why it is advantageous to include a short length of single mode gain fiber before the HOM gain fiber to boost the signal power level.

FIG. 3 is a combined graph 80, illustrating the following characteristics of an exemplary ytterbium-doped HOM fiber: a step refractive index profile 81, the electric field amplitude distribution of the fundamental LP_{(0,1)} mode 82, and the electric field amplitude distribution of the LP_{(0,10)} mode 83. As shown in the refractive index profile, the HOM fiber comprises three concentric regions: an up-doped inner core 81a that supports the LP_{(0,1)} mode; a doped, active (rare earth), outer core 81b that supports higher-order modes; and an undoped cladding region 81c. It is noted that refractive index profile 81 is exemplary, and that it is possible to practice the invention using fibers having different refractive index profiles. It is further noted that it is possible to implement refractive index profile 81, or its functional equivalent, using various doping schemes, including for example a doping scheme in which the outer cladding region 81c is doped.

Pumping of the HOM gain fiber can be achieved by either core-pumping using an HOM pump having the same mode number as the signal light, or by cladding-pumping uniformly exciting the entirety of the rare-earth doped region. Cladding-pumping is particularly attractive for ytterbium-based amplifiers because of the availability of low-cost multimode pump diodes. Note that for cladding pumping, the HOM fiber is further coated with low-index polymer.

FIG. 4 shows a schematic diagram of a cladding-pumped amplifier 90 according to the prior art, having only a single amplification stage. Amplifier 90 comprises a signal input 91, pump lasers 92 and 93 a pump-signal combiner 94, a long-period grating 95, and a length of HOM gain fiber 96, of the type illustrated in FIG. 3.

There are a number of issues associated with the cladding-pumped configuration 90 shown in FIG. 4. First, the doped core of an HOM gain fiber can be 110 μm in diameter, and can support hundreds of fiber modes. The number of modes supported by a core is N=V²/2, where V is the V-number of the core. For a fiber that has a core diameter of 110 μm, and numerical aperture (NA) of 0.13, the outer waveguide could support as many as 914 fiber modes. the ASE generated from quantum noise for each of these modes can add up to a large amount, and degrade the pump-to-signal conversion efficiency. To suppress this ASE, and to achieve high slope efficiency, an input signal with higher average power (on the order of 1 W or greater) needs to be injected into a cladding-pumped HOM amplifier.

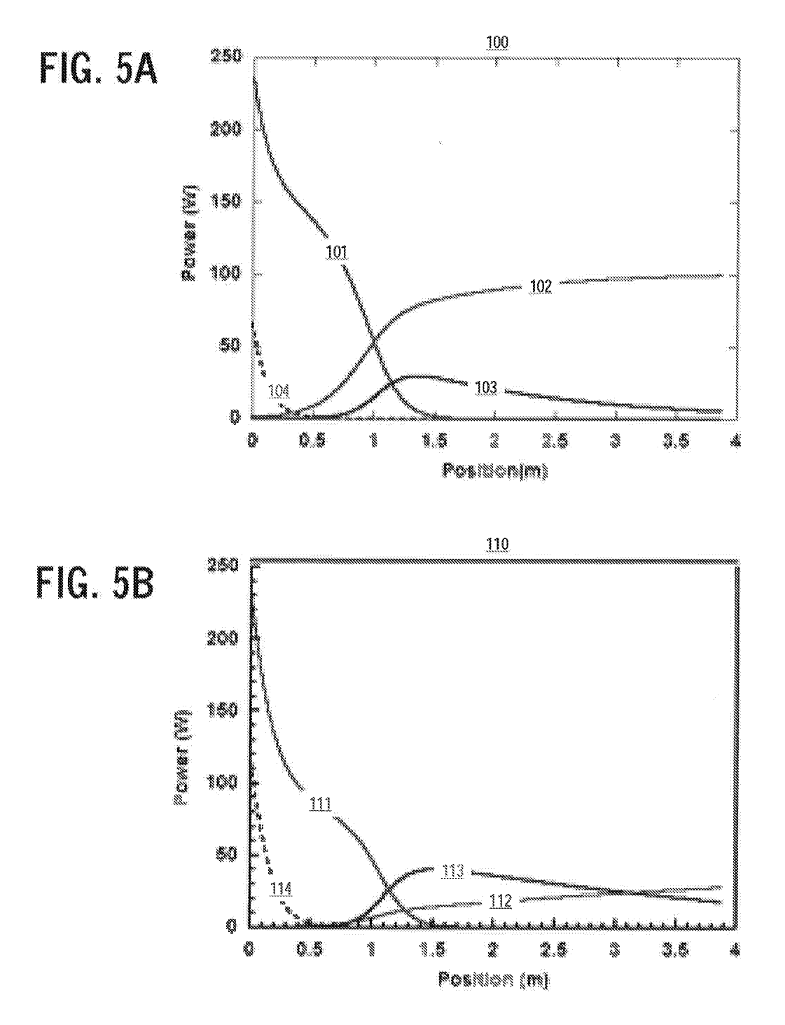

FIGS. 5A and 5B are graphs 100 and 110 that show the pump (plots 101 and 111), signal (plots 102 and 112), forward-propagating ASE power distribution (plots 103 and 113) and rearward-propagating ASE power distribution (plots 104 and 114), numerically simulated, for a single-stage HOM amplifier structure according to FIG. 4. In FIG. 5A, the input signal power is 1 W; in FIG. 5B, the input signal power is reduced by 90% to 100 mW.

For the purposes of the simulation, it is assumed that the gain fiber is pumped with 235 W @975 nm in the forward direction. It is further assumed that the HOM gain fiber has an undoped inner core, 7 μm in diameter, surrounded by an ytterbium-doped outer core with a diameter of 110 μm. The inner glass cladding, 356 μm in diameter, is assumed to be coated with low-index polymer to guide multimode pump radiation. The cladding absorption coefficient was estimated to be 40 dB/m at 975 nm.

From FIGS. 5A and 5B, it can be seen that, the ASE generated both in the forward and backward direction is much higher when the input signal power is 100 mw compared to that for an input signal power of 1 W. It will further be seen that the increase in generated ASE at 100 mW corresponds to a decrease in the amount of amplification of the input signal. Thus, from the viewpoint of low-ASE operation, it is preferable to operate the HOM fiber amplifier using a signal input of 1 W or greater.

It can, however, be difficult to provide with an input signal with the relatively high average power level required for low-ASE operation. For example, in pulsed operation, the input signal power is subject to limits imposed by different nonlinear limit effects. The seed pulses are typically created from low-power semiconductor laser operating in the pulsed mode followed by multiple stages of single-mode fiber amplifiers that are core- and/or cladding-pumped. Due to nonlinear effects such as the Kerr effect and the Raman effect, preparing nanosecond-pulses with a required power level over 1 W is rather challenging. For example, with respect to 1-nanosecond pulses at a 50-kHz repetition rate, the peak power becomes 20 kW, which could result in the generation of a significant Raman Stokes component and/or spectral broadening in an amplifier including a single-mode gain fiber or passive fiber pigtails.

According to an aspect of the invention, these problems are addressed in a cladding-pumped hybrid HOM fiber amplifier structure, in which a single-mode pre-amplification stage is used to amplify a relatively weak input light (e.g., 100 mW or less), raising it to a power level that is sufficiently high (e.g., 1 W or greater) to result in an acceptable low level of ASE in an HOM gain fiber into which the input light is launched. A spatial mode converter is located in between the two gain sections to convert the signal output from the single-mode gain fiber from the fundamental mode to a higher order mode LP_{(0,n)} before being launched into the HOM gain fiber section. The two gain fiber sections are excited using the same multimode pump light, which is launched into the pre-amplification stage, together with the signal light, through a multimode pump-and-signal combiner.

There are now described characteristics of a suitable single-mode gain fiber suitable for use in a pre-amplification stage in accordance with aspects of the invention.

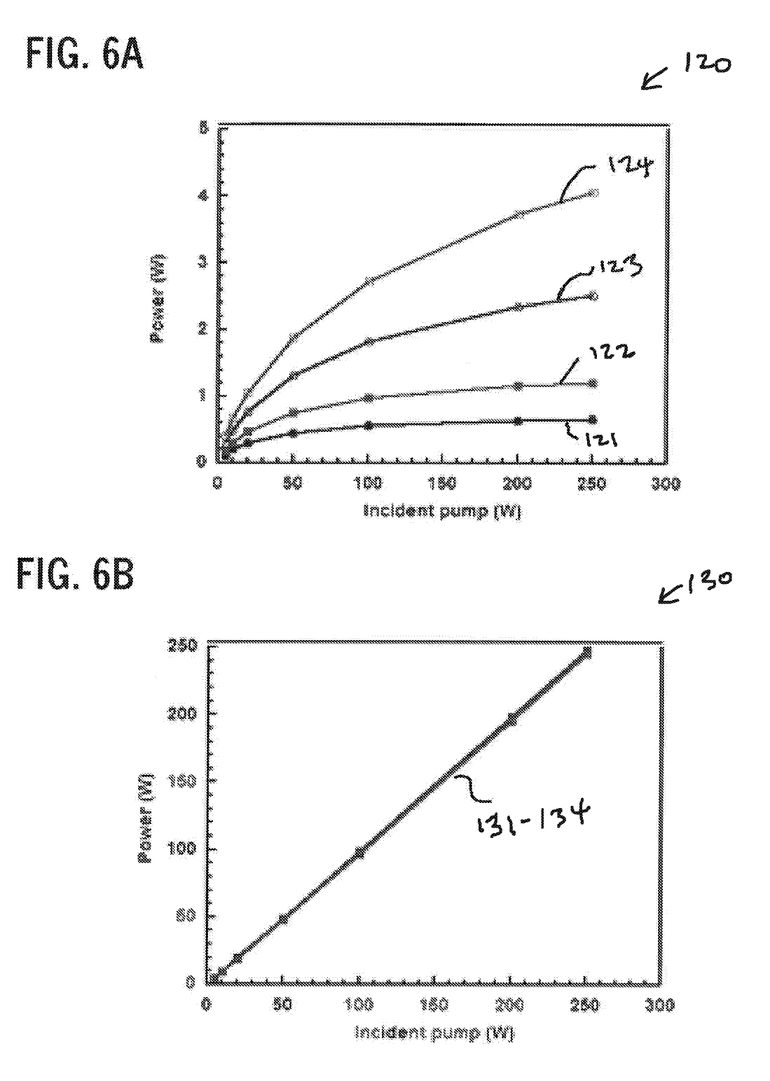

FIGS. 6A and 6B are graphs 120, 130 illustrating the amplification characteristics of a cladding-pumped single-mode gain fiber (11/200) amplifier. It is assumed that the pump wavelength is 975 nm, the signal wavelength is 1064 nm, the pump absorption is 426 dB/m in the core and 2.46 dB/m in the cladding.

In FIG. 6A, plots 121-124 show the amplified signal output power of the single-mode gain fiber as a function of pump power for 4 different input powers: 10 mW, 20 mW, 50 mW and 100 mW. FIG. 6B, plots 131-134 show the residual (i.e., unused) pump light for the same four input powers.

It can be seen in FIG. 6A that a pre-amplified signal power of over 1 W can be obtained with a relatively small signal input power (e.g., 20 mW˜100 mW) combined with a sufficiently high multimode pump light. In an exemplary practice of the invention, the input signal has a power level of 25˜100 mW. As shown in FIG. 6B, at all four input powers, very little pump light is used in amplifying the input signal. The residual (unabsorbed) pump light can thus be efficiently utilized for pumping the HOM gain fiber.

As mentioned above, it is desirable for the length of the single-mode gain fiber to be as short as possible, given the performance requirements for the gain fiber.

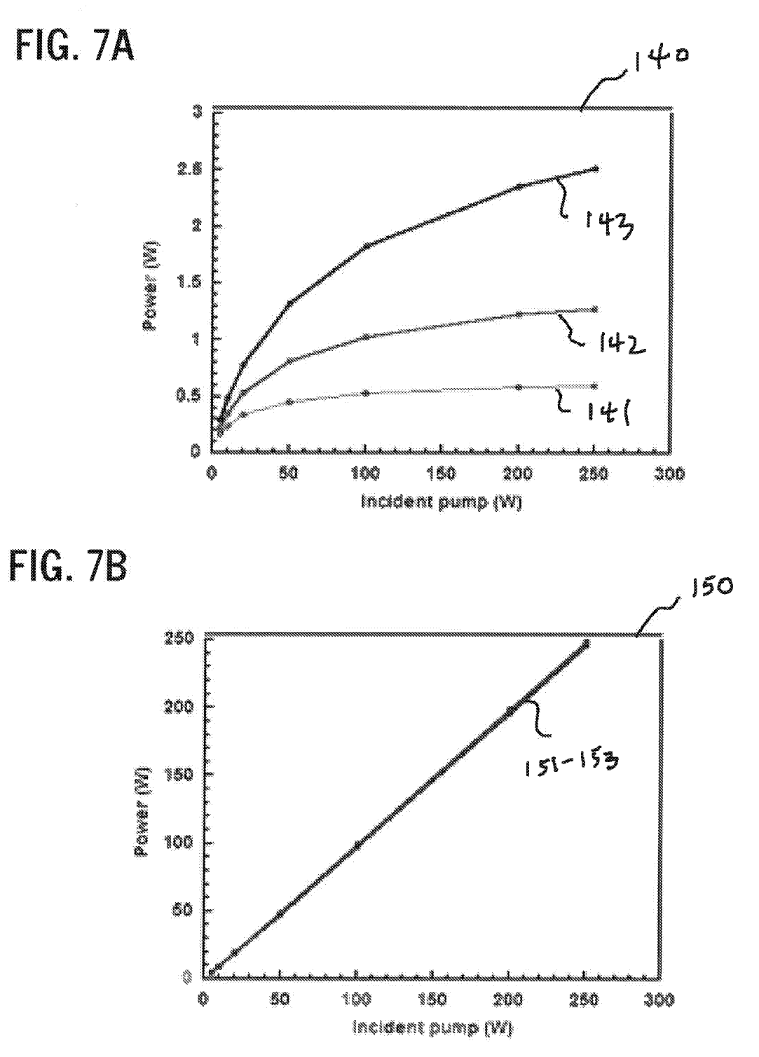

FIG. 7A is a graph 140 comparing the amplification characteristics of cladding-pumped single mode gain fiber (11/200) amplifier at three different lengths: 0.3 m (plot 141), 0.4 m (plot 142), and 0.5 m (plot 143). FIG. 7B is a graph 150 showing residual pump light as a function of incident pump light for the three lengths (plots 151-153). In FIGS. 7A and 7B, the following parameters are assumed: pump wavelength, 975 nm; signal wavelength, 1064 nm; pump absorption, 426 dB/m (core), 2.46 dB/m (cladding).

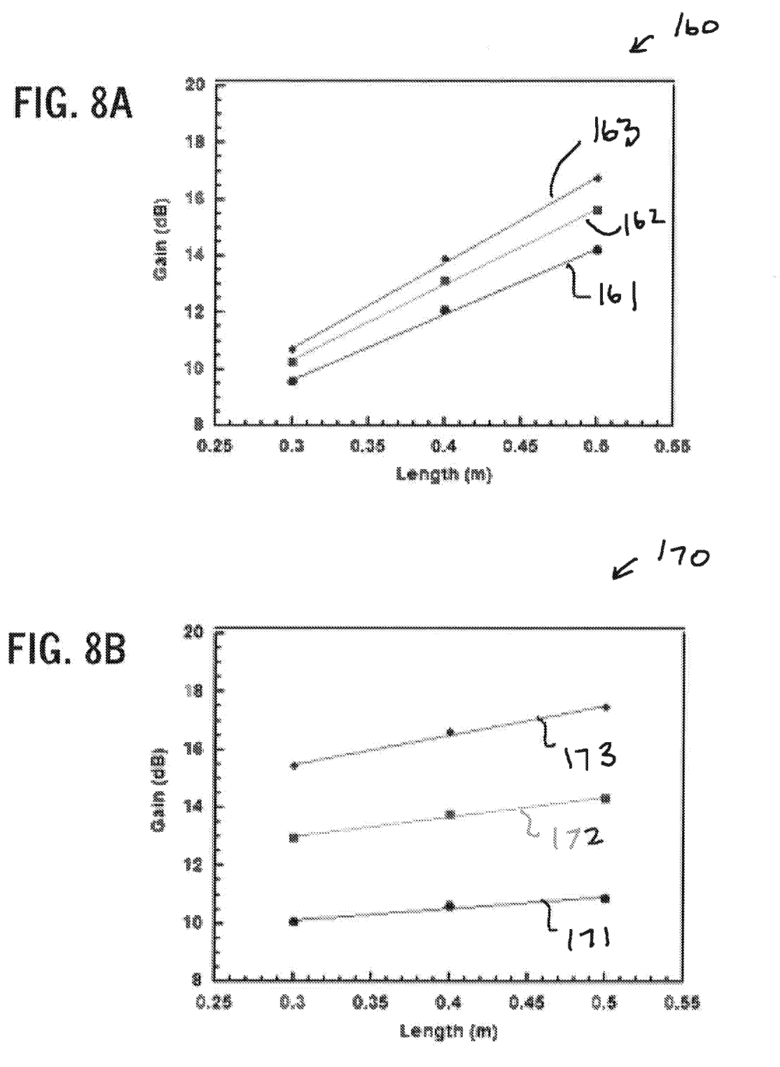

FIG. 8A and FIG. 8B are graphs 160 and 170 show the dependence of gain on the length of the single mode Yb gain fiber (11/200), calculated for 50 W (plots 161 and 171), 100 W (plots 162 and 172), and 200 W (plots 163 and 173) of multimode pump light @975 nm launched through the cladding. Input signal power is assumed to be 50 mW in FIG. 8A and 25 mW in FIG. 8B.

### Exemplary Embodiment

A cladding-pumped hybrid amplifier was constructed using the following components:

| | |
|---|---|
| first gain fiber | 0.5 m 11/200 [specify that these numbers refer to |
| | the diameters in microns?] single-mode, |
| | ytterbium-doped gain fiber (YDF) |
| second gain fiber | 3.8 m HOM ytterbium doped fiber (HOM-YDF) |
| pump source | multimode laser diodes |
| pump/signal combiner | tapered fiber bundle (TFB) coupler |
| mode converter | long-period grating (LPG) inscribed into the |
| | HOM gain fiber |

The modefield diameter (MFD) of the TFB output fiber, the YDF first gain fiber and the inner core of the HOM-YDF second gain fiber is 11 μm. The components are spliced together with low loss. The HOM-YDF second gain fiber is directly spliced to the YDF first gain fiber. The LPG mode converter is inscribed into the input end of the HOM-YDF second gain fiber, and is configured to convert an LP_{(0,1)} mode input into an LP_{(0,10)} mode output. The composite structure is pumped using multimode laser diodes connected to the pump ports of the TFB coupler.

The amplifier is operated using a signal input comprising an 8-ns pulse train with a 250 kHz repetition rate and an average power of 115 mW.

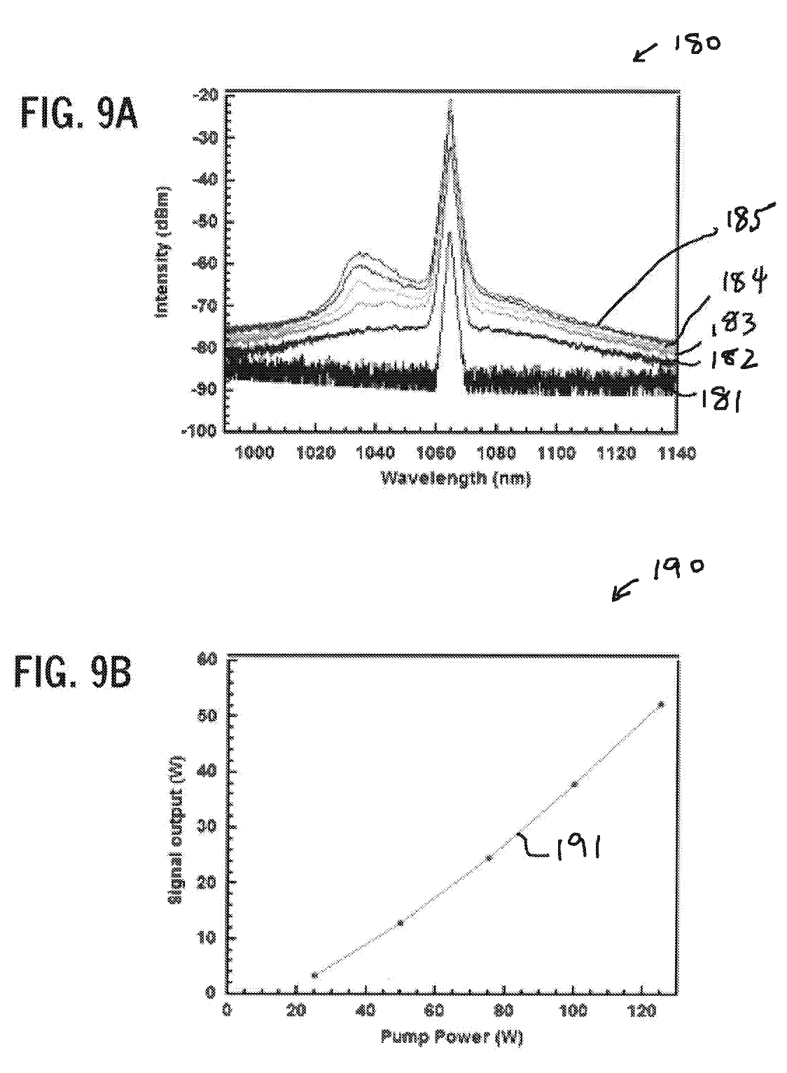

FIG. 9A is a graph 180 showing the optical spectra of the amplifier output for the following pump powers: 0 W, 25 W, 50 W, 75 W, 100 W, 125 W (plots 181-185). FIG. 9B is a graph 190, in which plot 191 shows the average output power plotted as a function of pump power, showing a slope efficiency as high as 57%. The highest average power attained is 52 W, corresponding to a highest peak power of 26 kW, which is obtained using a 125 W pump light.

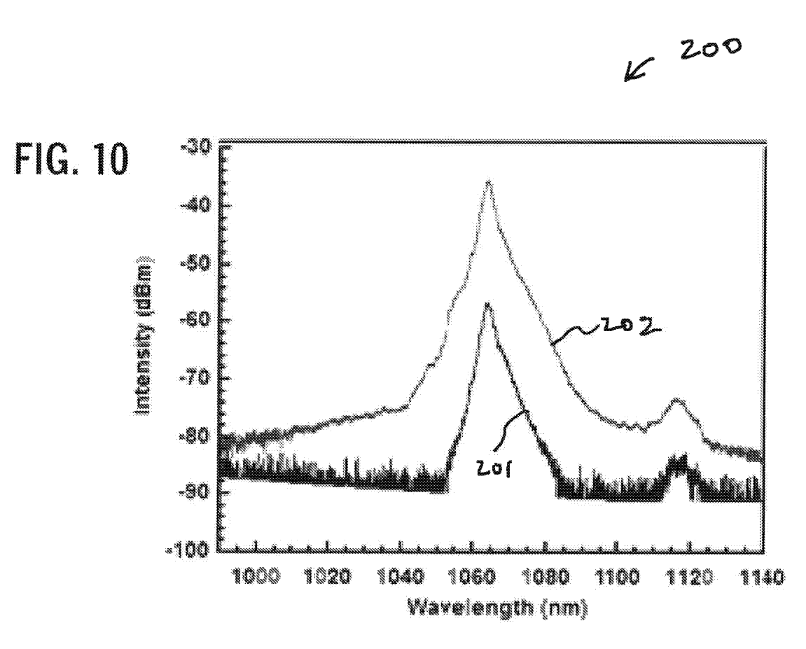

FIG. 10 is a graph 200 showing the optical spectra of the amplifier output at pump powers of 0 W (plot 201) and 25 W (plot 202), where the input signal is a 8-ns pulse train, with a 50 kHz repetition rate and an average power of 116 mW.

It will be seen that the addition of a single-mode gain fiber prior to the HOM-gain fiber helps to improve the purity of the HOM mode. Since the first amplification stage is single-moded, it only amplifies the light guided in the core, leaving unamplified any light trapped in the cladding region. This arrangement can thus greatly improve the purity (from 90% to 99%) of the LP_{(0,1)} signal light entering the HOM gain section, if there is assumed to be a 10 dB gain in the first amplification stage.

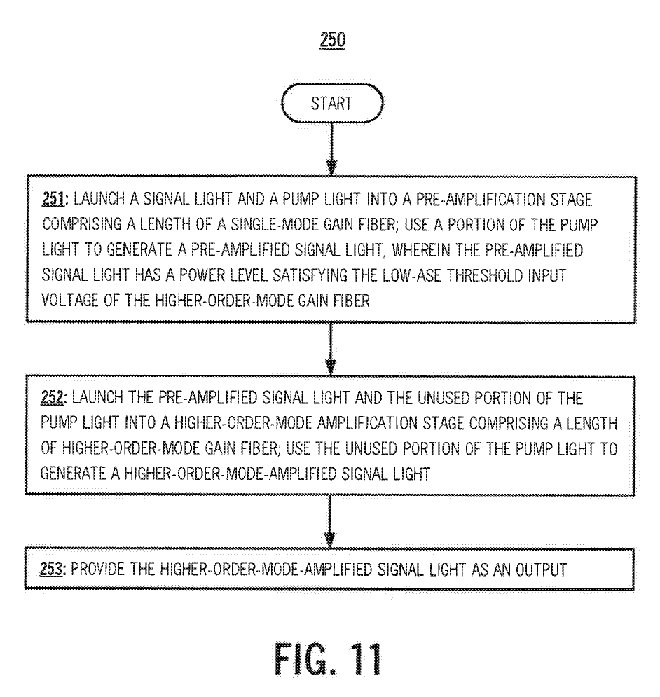

FIG. 11 is a flowchart of a general method 250 according to a further aspect of the invention for providing higher-order-mode amplification of a signal light having a power level below a low-ASE signal input threshold of a higher-order-mode gain fiber. Method 250 comprises the following steps:

251: Launching a signal light and a pump light into a pre-amplification stage comprising a length of a single-mode gain fiber; and using a portion of the pump light to generate a pre-amplified signal light, wherein the pre-amplified signal light has a power level satisfying the low-ASE threshold input signal of the higher-order-mode gain fiber.

252: Launching the pre-amplified signal light and the unused portion of the pump light into a higher-order-mode amplification stage comprising a mode converter and a length of higher-order-mode gain fiber; and using the unused portion of the pump light to generate a higher-order-mode-amplified signal light.

253: Providing the higher-order-mode-amplified signal light as an output.

In essence, according to the invention, the two amplifier stages are cascaded in such a way that the effective area of the signal is increased as the signal propagates from one stage to another, so that nonlinear impairments can be minimized. Consequently, the technique can be extended to two amplifier stages where the second gain fiber has a larger V-number than the first gain fiber. The V-number is defined as:

$$V = \frac{2 π}{λ} a N A$$

where λ is the vacuum wavelength, a is the radius of the fiber core, and NA is the numerical aperture.

For example, it would be possible to obtain the same benefit by choosing a single-mode or a few-mode gain fiber for the first stage, and multimode gain fiber for the second stage, and incorporate a means to convert the transverse mode of the signal between stages so that the effective area is increased as the signal transits from one stage to the next.

Furthermore, the technique can be extended from two stages to a larger number of stages for enhancing the overall gain, while minimizing the ASE as well as nonlinear impairments.

It is noted that the structures and techniques described herein may be applied in other contexts, including for example Raman amplification.

### Theoretical Analysis of a Hybrid HOM Amplifier

There is now provided a theoretical analysis of a hybrid HOM amplifier according to an aspect of the invention.

Since the depletion of the pump in the first amplifier section (length L₁) is negligibly small, one can assume small signal amplification of the signal with a constant gain. The distribution of signal (average power) along the single mode gain fiber can be expressed as the following Equation (1):

Pₛ=P₀e^{gz}, Eq. (1)

where the gain g is related to upper and lower state populations N2, N1 and the absorption and emission cross-sections as set forth in the following Equation (2):

g=(N₂σₛ^{e}−N₁σₛ^{p}). Eq. (2)

In order to suppress the amplified spontaneous emission (ASE), it is important that the output of stage 1 amplifier satisfies the following Equation (3):

Pₒe^{gL}^{₁}>>(hvB)M. Eq. (3)

Here, the term on the right side represents the total ASE quantum noise generated over bandwidth B in M number of modes supported by the rare-earth doped core of HOM fiber.

For efficient amplification, the amplified signal power needs to be larger than (hvBM) by Q times (Q>>1), as set forth in the following Equation (4):

Pₒe^{gL}^{₁}=Q(hvBM). Eq. (4)

For pulsed operation it is important to estimate the amount of spectral broadening due to nonlinear Kerr effect and also the amount of Stokes power being generated due to Raman scattering.

### Nonlinear Spectral Broadening in the Stage 1 Amplifier

### Estimation of Nonlinear Phase Change (B-integral)

The nonlinear phase change for pulsed signal with period T and pulsewidth (Δτ) can be calculated from the following Equation (4), in which γ is the nonlinear gain coefficient:

$${φ}_{NL} = \frac{T}{Δ τ} {\int }_{0}^{{L}_{1}} γ {P}_{s} dz = \frac{T γ {P}_{0}}{Δ τ g} ( {e}^{{gL}_{1}} - 1 ) \approx \frac{T γ {P}_{0} {e}^{{gL}_{1}}}{Δ τ g} = \frac{T γ hvBMQ}{Δ τ g} . \qquad Eq . ( 5 )$$

Now the frequency chirp due to self-phase modulation (SPM) can be approximated by the following Equation (5):

$$Δ {v}_{chirp} = 2 \cdot \frac{1}{2 π} \frac{{φ}_{NL l}}{Δ τ / 2} = \frac{2 T γ hvBMQ}{{π ( Δ τ )}^{2} g} . \qquad Eq . ( 6 )$$

Therefore, the degree of nonlinear spectral broadening (NSB) can be expressed as,

NSB=Δv_{chirp}/(1/Δτ). Eq. (7)

Plugging the Equation (6) approximation for Δv_{chirp} into Equation (7) yields the following Equation (8):

$$N S B = \frac{2 T γ hvBMQ}{π Δ τ g} = \frac{Q}{g} \cdot \frac{M}{{A}_{eff}} \cdot \frac{T}{Δ τ} \cdot ( \frac{4 {n}_{2} hvB}{λ} ) . \qquad Eq . ( 8 )$$

### Estimation of Stimulated Raman Scattering (SRS)

Evaluation of Raman Stokes wave in the first amplifier section originating from quantum noise can be expressed as the following Equation (9):

$$\frac{{dP}_{R}}{dz} = ( {P}_{R} + {N}_{R} ) {G}_{R} , \qquad Eq . ( 9 )$$

where P_{R} is the Stokes power, and N_{R} is the quantum noise generated from Raman scattering given by Equation (10):

N_{R}=hv_{Stokes}B_{Stokes}, Eq. (10)

and G_{R} is the position-dependent Raman gain given by Equation (11):

$${G}_{R} ( z ) = \frac{{P}_{s} ( z ) / {A}_{eff}}{Δ τ / T} \cdot {g}_{R} = \frac{{P}_{o} {Tg}_{R}}{Δ τ {A}_{eff}} {e}^{gz} . \qquad Eq . ( 11 )$$

Equation (9) is a first order linear differential equation, the solution of which is

$${P}_{R} ( z ) = {N}_{R} ⌊ {e}^{( {e}^{gz} - 1 ) k / g} - 1 ⌋ . \qquad Eq . ( 12 )$$

Here,

$$k = \frac{{P}_{o} {Tg}_{R}}{Δ τ {A}_{eff}} . \qquad Eq . ( 13 )$$

At the amplifier output, z=L₁, yielding the following Equation (14):

$${P}_{R} ( z = {L}_{1} ) = {N}_{R} ⌊ {e}^{( {e}^{{gL}_{1}} - 1 ) k / g} - 1 ⌋ \approx {N}_{R} {e}^{{e}^{{gL}_{1}} k / g} . \qquad Eq . ( 14 )$$

The signal to noise ratio at the output of first amplifier section can be expressed as the following Equation (15):

$$S N R ( dB ) = 10 log ( \frac{{P}_{s} ( z = {L}_{1} )}{{P}_{R} ( z = {L}_{1} )} ) . \qquad Eq . ( 15 )$$

The value for numerator Pₛ(z=L₁) can be derived from Equation (4). The value for denominator P_{R}(z=L₁) can be derived using Equations (10) and (14). Plugging these values into Equation (15) yields the following Equation (16):

$$S N R ( dB ) = 10 log ( \frac{vBMQ}{{v}_{Stokes} {B}_{Stokes}} ) - 4.343 * \frac{Q}{g} \cdot \frac{M}{{A}_{eff}} \cdot \frac{T}{Δ τ} ( {g}_{R} hvB ) . \qquad Eq . ( 16 )$$

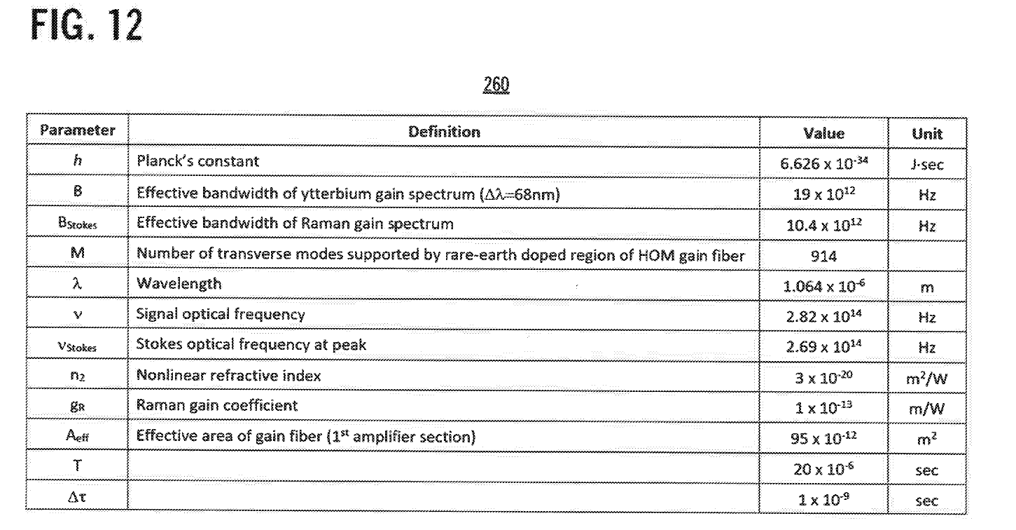

In the following, the implications of these formalism are shown using experimental parameters related to a hybrid Yb:HOM amplifier. FIG. 12 shows a table 260 laying out these parameters.

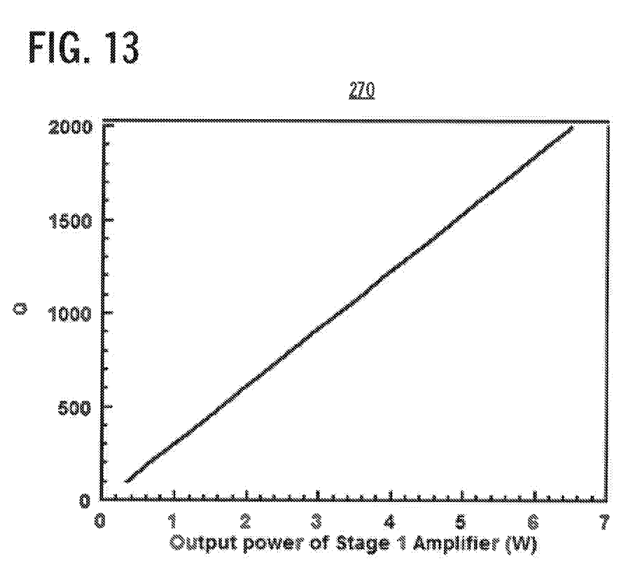

FIG. 13 is a graphical representation 270 of Equation (4), showing the required value for Q for different output power of stage 1 amplifier. For efficient operation of Yb:HOM amplifier, an input signal power of 1 to 6 W should be sufficient, which corresponds to Q in the range of 200˜2000.

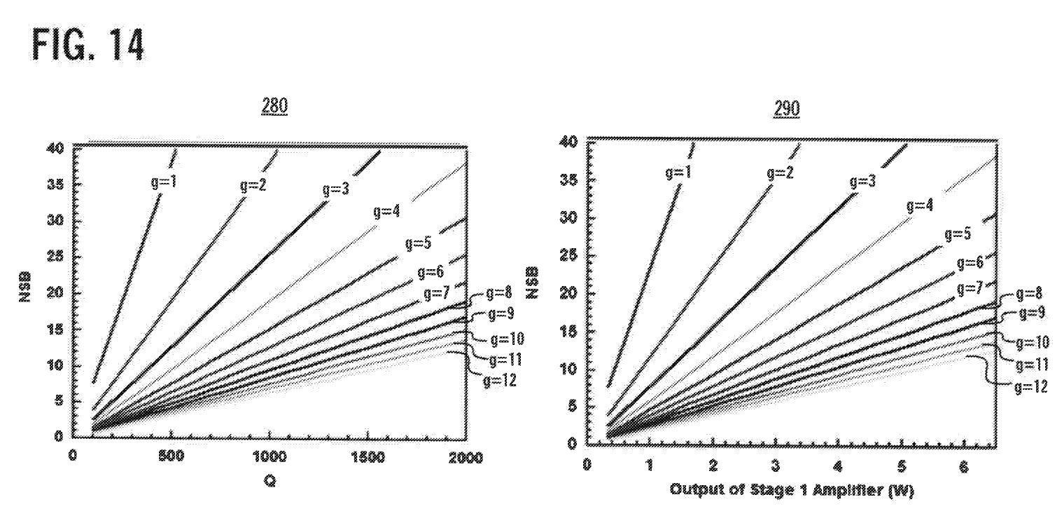

FIG. 14 shows a pair of graphical representations of Equation (8). Graph 280 illustrates nonlinear spectral broadening as a function of Q, and graph 290 illustrates nonlinear spectral broadening as a function of the output of the stage 1 amplifier, plotted for different gain coefficients, g=1/m to g=12/m.

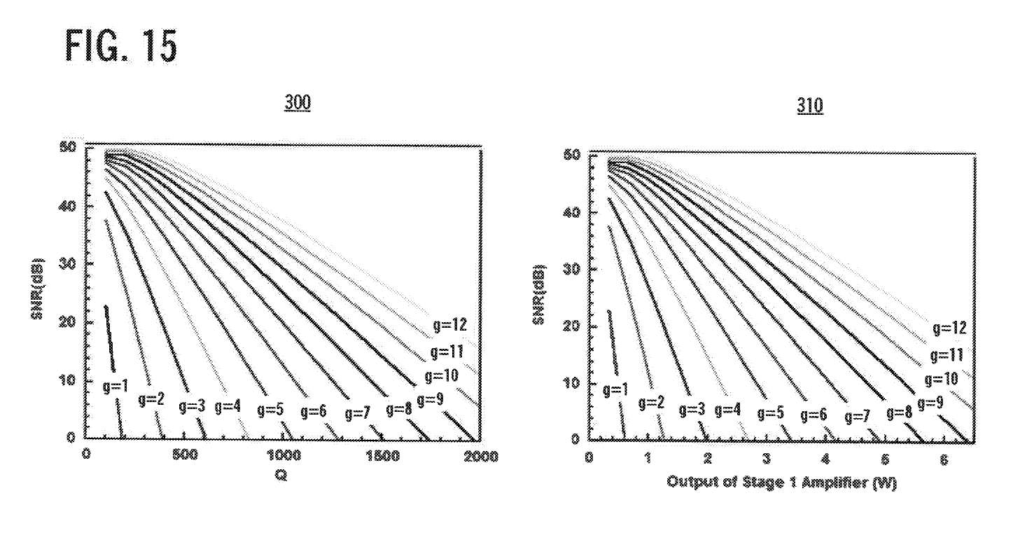

FIG. 15 shows a pair of graphical representations of Equation (13). Graph 300 illustrates signal-to-noise ratio as a function of Q, and graph 310 illustrates signal-to-noise ration as a function of the output of the stage 1 amplifier, plotted for different gain coefficients, g=1/m to g=12/m.

From FIG. 15, one can find the minimum gain coefficient needed to obtain SNR above a certain value and for a desired Q value or amplifier output. For example, if Q=1000, and SNR needs to be larger than 30 dB, than, gain coefficient should be g>9/m.

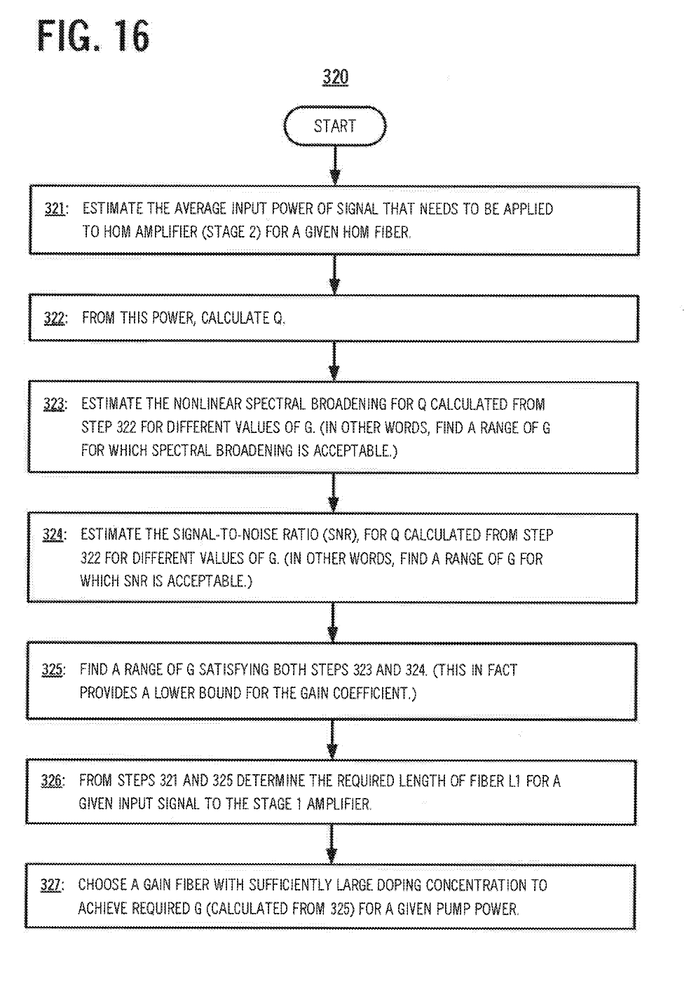

In summary, the design of an HOM amplifier according to an aspect of the invention involves the following steps, set forth in the flowchart 320 show in FIG. 16:
Step 321: Estimate the average input power of signal that needs to be applied to HOM amplifier (stage 2) for a given HOM fiber.
Step 322: From this power calculate Q (e.g., by using Equation 4).
Step 323: Estimate the nonlinear spectral broadening for Q calculated from step 322 for different values of g. (In other words, find a range of g for which spectral broadening is acceptable.)
Step 324: Estimate the signal-to-noise ratio (SNR), for Q calculated from step 322 for different values of g. (In other words, find a range of g for which SNR is acceptable.)
Step 325: Find a range of g satisfying both steps 323 and 324. (This in fact provides a lower bound for the gain coefficient.)
Step 326: From steps 321 and 325 determine the required length of fiber L1 for a given input signal to the stage 1 amplifier.
Step 327: Choose a gain fiber with sufficiently large doping concentration to achieve required g (calculated from 325) for a given pump power.

### CONCLUSION

While the foregoing description includes details that will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A fiber amplifier, comprising:
a first fiber amplification stage comprising a first gain fiber having an input end and an output end, wherein the first gain fiber is configured:
to receive, at its input end, a signal light and a pump light;
to use a portion of the pump light to provide first-stage amplification to the signal light; and
to provide, at its output end, first-stage-amplified signal light and residual pump light;
a second fiber amplification stage, comprising a second gain fiber having an input end and an output end, wherein the second gain fiber is configured:
to receive, at its input end, the first-stage-amplified signal light and residual pump light;
to use the residual pump light to provide second-stage amplification of the first-stage-amplified signal light; and
to provide, at its output end, the second-stage amplified signal light.

2. The fiber amplifier of claim 1,
wherein, the second gain fiber is configured to support a larger number of modes than the number of modes supported by the first gain fiber.

3. The fiber amplifier of claim 1,
wherein the first gain fiber comprises a single-mode gain fiber,
wherein the second gain fiber stage comprises a higher-order mode gain fiber,
wherein the input signal light comprises a fundamental-mode light, and
wherein the first-stage-amplified signal light comprises the fundamental-mode signal light, amplified by the single-mode gain fiber; and
wherein the second-stage amplified signal light comprises the first-stage amplified signal light amplified by the higher-order mode gain fiber.

4. The fiber amplifier of claim 3,
further comprising a mode converter connected between the single-mode gain fiber and the higher-order mode gain fiber for converting the fundamental-mode output of the first gain fiber to one or more selected higher-order mode supported by the higher-order mode gain fiber.

5. The fiber amplifier of claim 4,
wherein the mode converter comprises a long-period grating inscribed into a region of the second gain fiber proximate to its input end.

6. The fiber amplifier of claim 5,
wherein the long-period grating is located within 10 cm of the input end of the second gain fiber section.

7. The fiber amplifier of claim 3,
wherein the first and second gain fibers comprise a respective double-clad fiber,
wherein each double-clad fiber comprises a respective core region and a cladding region surround the core region, wherein the cladding region is configured to support the propagation of a multimode pump light used to amplify a signal light guided by the core region.

8. The fiber amplifier of claim 1,
further comprising a pump/signal combiner for launching a fundamental mode signal combined with a multimode pump light into the first amplification stage in a forward direction.

9. The fiber amplifier of claim 1, wherein the two gain fiber sections are doped with one or more rare earth ions in order to provide gain to the input signal.

10. The fiber amplifier of claim 1, wherein the signal light is a continuous wave light.

11. A fiber amplifier according to claim 1, wherein the signal is pulsed.

12. A fiber amplifier according to claim 11, wherein the pulse repetition rate is higher than 10 kHz for ytterbium doped fiber amplifier and higher than 1 kHz for erbium doped fiber amplifier.

13. A fiber amplifier according to claim 3, wherein the length of the HOM gain fiber before the mode converter is less than 10 cm.

14. A fiber amplifier according to claim 3, wherein the length of the single-mode gain fiber is 0.2 to 1 m, while the gain is 5 dB to 18 dB.

15. A method for providing higher-order-mode amplification of a signal light having a power level below a low-ASE signal input threshold of a higher-order-mode gain fiber, comprising:
(a) launching the signal light and a pump light into a pre-amplification stage comprising a length of a single-mode gain fiber, and using a portion of the pump light to generate a pre-amplified signal light;
(b) launching the pre-amplified signal light and an unused portion of the pump light into an amplification stage comprising a length of the higher-order-mode gain fiber, and using the unused portion of the pump light to generate a higher-order-mode-amplified signal light; and
(c) providing the higher-order-mode-amplified signal light as an output,
wherein the pre-amplified signal light generated by the pre-amplification stage has a power level satisfying the low-ASE threshold input power of the higher-order-mode gain fiber.

16. A method for configuring a hybrid HOM amplifier, comprising:
(a) estimating the average input power of signal to be applied to a second-stage HOM amplifier for a given HOM fiber;
(b) calculating Q based on the power estimated in step (a);
(c) estimating the nonlinear spectral broadening for Q for different values of g;
(d) estimating the signal-to-noise ratio (SNR) for Q for different values of g;
(e) finding a range of g satisfying both steps (c) and (d);
(f) from steps (a) and (e), determining the required length for a given input signal to a first-stage amplifier; and
(g) choosing a a gain fiber with sufficiently large doping concentration to achieve required g for a given pump power.
